(19) United States
(12) Patent Application Publication
(10) Pub. No.: US 2025/0087663 A1
(43) Pub. Date: Mar. 13, 2025

(54) ELECTRODE ASSEMBLY AND RECHARGEABLE BATTERY WITH THE SAME

(71) Applicant: SAMSUNG SDI CO., LTD., Yongin-si (KR)

(72) Inventor: Bohoon KIM, Yongin-si (KR)

(21) Appl. No.: 18/742,531

(22) Filed: Jun. 13, 2024

(30) Foreign Application Priority Data
Sep. 8, 2023 (KR) 10-2023-0119986

(51) Int. Cl. H01M 4/13; H01M 4/02; H01M 4/70; H01M 10/0525; H01M 10/0587; H01M 10/42

(52) U.S. Cl. CPC H01M 4/13; H01M 4/70; H01M 10/0525; H01M 10/0587; H01M 10/4235; H01M 2004/027

(57) ABSTRACT

An electrode assembly includes a separator, and a first electrode and a second electrode positioned across the separator. The separator, the first electrode, and the second electrode are wound around two winding axes and then implement a shape including a central portion and a pair of rounded portions positioned at both sides (e.g., opposite sides) of the central portion. The first electrode includes a first substrate having an inner end, a first composite material layer positioned on a part of the first substrate at a distance from the inner end, and a protection layer positioned on the inner surface of a bent part of the first substrate at a distance from the inner end and the first composite material layer.

### CROSS-REFERENCE TO RELATED APPLICATION

The present application claims priority to and the benefit of Korean Patent Application No. 10-2023-0119986, filed on Sep. 8, 2023, in the Korean Intellectual Property Office, the entire content of which is incorporated herein by reference.

### BACKGROUND

### 1. Field

The present disclosure relates to a rechargeable battery. For example, the present disclosure relates to the structure of an electrode assembly to suppress or reduce an occurrence of cracks in an electrode.

### 2. Description of the Related Art

Rechargeable batteries are used for a variety of purposes, such as powering small electronic devices (such as mobile phones and/or laptop computers), and powering motors for transportation vehicles (such as electric vehicles and/or hybrid vehicles). Rechargeable batteries basically include an electrode assembly and a case that seals the electrode assembly, and may be classified into cylindrical batteries, prismatic batteries, and pouch-type or kind batteries depending on their shapes and/ir appearances.

The electrode assembly may be a flat jelly roll type or kind in which a strip-shaped positive electrode and a negative electrode are laminated with a separator in between and wound around two winding axes (spaced from each other). During the charging and discharging process of the rechargeable batteries, the electrode assembly repeats a contraction and an expansion, and such repeated volume changes in the electrode assemblies may cause damage such as cracks to the electrode substrate. The damage to these electrodes may cause an ignition of the rechargeable battery and/or may degrade the safety of the rechargeable battery.

### SUMMARY

Aspects according to embodiments of the present disclosure are directed toward an electrode assembly and a rechargeable battery equipped with the same that may suppress or reduce damage to the electrodes due to repeated volume changes of the electrode assembly. Additional aspects will be set forth in part in the description which follows and, in part, will be apparent from the description, or may be learned by practice of the presented embodiments of the disclosure.

An electrode assembly according to one or more embodiments includes a separator, and a first electrode and a second electrode positioned across the separator. The separator, the first electrode, and the second electrode are wound around two winding axes (parallel to and spaced from each other other) and are in a shape including a central portion and two rounded portions at (e.g., on) opposite sides of the central portion. The first electrode includes a first substrate having an inner end, an inner surface, and a bent part spaced from the inner end, a first composite material layer on a part of the first substrate spaced from the inner end, and a protection layer on the inner surface of the first substrate at the bent part and spaced from the first composite material layer.

The first substrate may include a plurality of flat portions corresponding to the central portion and a plurality of bent portions corresponding to the two rounded portions. On the inner surface of the first substrate, the first composite material layer may be positioned across two or more bent portions of the plurality of bent portions from the inner end of the first substrate. The plurality of bent portions may include a first bent portion, a second bent portion, and a third bent portion in order of proximity to the inner end, and the protection layer may overlap the second bent portion.

The protection layer may include a first portion that overlaps the second bent portion, and two second portions at (e.g., on) opposite sides of the first portion and each overlap a portion of the plurality of flat portions. A width of each of the two second portions along a length direction of the first substrate may be greater than or equal to a width of the first portion and less than or equal to a width of a flat portion of the plurality of flat portions. On the inner surface of the first substrate, the first composite material layer may overlap the third bent portion.

The protection layer may include (e.g., consist of) a polymer film and an adhesive layer on at least one surface of the polymer film, the protection layer being attached to the first substrate. The protection layer may include a folding line at the bent part, the folding line being parallel to a width direction of the first substrate to facilitate the bending of the first substrate and the protection layer. The protection layer may include (e.g., consist of) a coating film including at least one of polyimide (PI), polyethylene terephthalate (PET), ceramics, or a negative active material.

An electrode assembly according to one or more embodiments includes a separator, and a positive electrode and a negative electrode stacked across the separator. The separator, the positive electrode, and the negative electrode may be wound around two winding axes (parallel to and spaced from each other) and be in a shape including a central portion and two rounded portions at (e.g., on) opposite sides of the central portion. The negative electrode may include a substrate having an inner end and an inner surface, a composite material layer, and a protection layer. The substrate may include a plurality of flat portions corresponding to the central portion and a plurality of bent portions corresponding to the two rounded portions, the plurality of bent portions including a first bent portion, a second bent portion, and a third bent portion in order of proximity to the inner end. On the inner surface of the substrate, the composite material layer may be further away from the inner end than the second bent portion is from the inner end, and the protection layer may be on the inner surface of the substrate at the second bent portion.

A width of the protection layer along a length direction of the substrate may be more than three times a width of the second bent portion, and a thickness of the protection layer may be greater than a thickness of the substrate. The protection layer may include (e.g., consist of) a polymer film attached to the substrate by an adhesive layer or a coating film formed by being coated on the substrate. The protection layer may include (e.g., consist of) the polymer film and may include a folding line parallel to a width direction of the substrate to facilitate bending of the substrate and the protection layer. The composite material layer may overlap the third bent portion on the inner surface of the substrate.

A rechargeable battery according to one or more embodiments may include an electrode assembly of the above-described configurations, a can that accommodates the electrode assembly, and a cap assembly that is coupled to an end of the can and seals the can.

According to one or more embodiments, the rechargeable battery may suppress or reduce an occurrence of cracks in the bent portion and a generation of by-products inside the electrode assembly in an environment where expansion and contraction of the electrode assembly are repeated during charging and discharging, and may improve driving stability and lifespan characteristics.

### BRIEF DESCRIPTION OF THE DRAWINGS

The accompanying drawings are included to provide a further understanding of the present disclosure, and are incorporated in and constitute a part of this specification. The drawings illustrate embodiments of the present disclosure and, together with the description, serve to explain principles of the present disclosure. In the drawings:

FIG. 1 is an exploded perspective view of a rechargeable battery according to a first embodiment.

FIG. 2 is an enlarged view of a region A shown in FIG. 1.

FIG. 3 and FIG. 4 are perspective views showing an unfolded state of a first electrode in the electrode assembly shown in FIG. 1.

FIG. 5 is a partially enlarged view of a region where a protection layer is positioned in the electrode assembly shown in FIG. 1.

FIG. 6 is a schematic diagram showing an electrode assembly of a comparative example without a protection layer.

FIG. 7 is a partial enlargement of an electrode assembly of one or more embodiments equipped with a protection layer.

FIG. 8 is a partial enlargement of an electrode assembly of one or more embodiments equipped with a protection layer.

FIG. 9 is a perspective view showing an unfolded state of a first electrode of a rechargeable battery according to a second embodiment.

FIG. 10 is a partial top plan view showing a wound state of the first electrode shown in FIG. 9.

FIG. 11 is a partial enlargement of an electrode assembly of a rechargeable battery according to a third embodiment.

FIG. 12 and FIG. 13 are perspective views each showing an unfolded state of a first electrode of a rechargeable battery according to a fourth embodiment.

FIG. 14 is a partial enlargement of an electrode assembly of a rechargeable battery according to a fifth embodiment.

FIG. 15 is an exploded perspective view of a rechargeable battery according to a sixth embodiment.

FIG. 16 is a cross-sectional view of a rechargeable battery according to the sixth embodiment.

FIG. 17 and FIG. 18 are perspective views each showing an unfolded state of a first electrode in the electrode assembly shown in FIG. 15.

### DETAILED DESCRIPTION

The present disclosure will be described more fully hereinafter with reference to the accompanying drawings, in which embodiments of present disclosure are shown. As those skilled in the art would realize, the described embodiments may be modified in various suitable different ways, all without departing from the spirit or scope of the present disclosure.

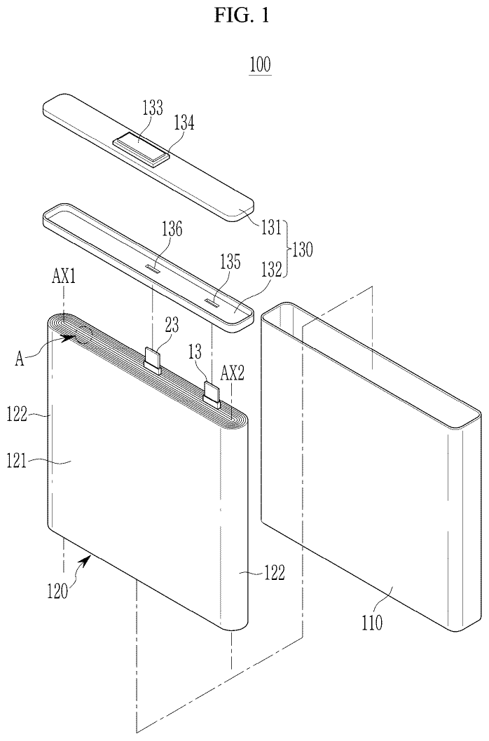

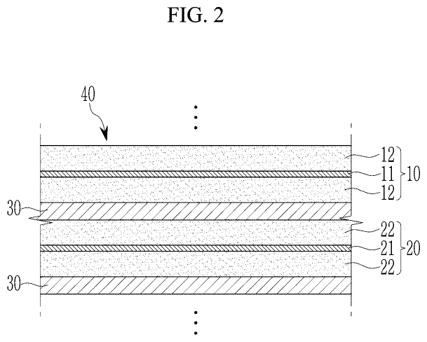

FIG. 1 is an exploded perspective view of a rechargeable battery according to a first embodiment, and FIG. 2 is an enlarged view of a region A shown in FIG. 1.

Referring to FIG. 1 and FIG. 2, the rechargeable battery 100 may include a can 110, an electrode assembly 120 accommodated inside the can 110, and a cap assembly 130 that is coupled to the end of the can 110 and seals the can 110.

The electrode assembly 120 may include a first electrode 10, a second electrode 20, and a separator 30. The separator 30 may be positioned between the first electrode 10 and the second electrode 20, and insulates them from each other.

The first electrode 10, the second electrode 20, and the separator 30 may be configured in the shape of a long strip, and are wound around two winding axes AX1 and AX2 to realize the shape of a flat jelly roll.

For example, the first electrode 10, the (e.g., first) separator 30, the second electrode 20, and the (e.g., second) separator 30 may be sequentially stacked to form a laminate 40. The laminate 40 may be wound around the first winding axis AX1 and the second winding axis AX2 positioned at a distance from each other. For example, the laminate 40 may be wound continuously and alternately around the first winding axis AX1 and the second winding axis AX2.

Depending on the winding of the laminate 40, the shape of the electrode assembly 120 may include a flat rectangular central portion 121 and a pair of rounded portions 122 positioned on both sides (e.g., opposite sides) of the central portion 121. The central portion 121 may be a flat portion of a certain thickness positioned between the first winding axis AX1 and the second winding axis AX2. The pair of rounded portions 122 may be a semicircular curved portion around (e.g., surrounding) a respective one of the two winding axes AX1 and AX2.

The first electrode 10 may include a first substrate 11 and a first composite material layer 12 positioned on the first substrate 11. The first electrode 10 may include a first electrode tab 13 extending from the first substrate 11 to one side (e.g., an upper side). The second electrode 20 may include a second substrate 21 and a second composite material layer 22 positioned on the second substrate 21. The second electrode 20 may include a second electrode tab 23 extending from the second substrate 21 to one side (e.g., the upper side).

In a lithium-ion rechargeable battery, the first substrate 11 may be composed of a copper foil or a nickel foil, and the first composite material layer 12 may include graphite, a conductive material, and a binder. The second substrate 21 may be composed of an aluminum foil, and the second composite material layer 22 may include a transition metal oxide (such as LiCoO₂, LiNiO₂, LiMn₂O₄, Li(NiCoAI) O₂, LiFePO₄, Li(NiCoMn) O₂, and/or the like), a conductive material, and a binder. The first electrode 10 may be referred to as a negative electrode, and the second electrode 20 may be referred to as a positive electrode.

The separator 30, which may include a polymer material such as polyethylene or polypropylene, insulates (e.g., is an electron insulator to insulate) the first electrode 10 and the second electrode 20 from each other while allowing the movement of lithium ions (e.g., is also an ionic conductor). The electrode assembly 120 may be accommodated inside the can 110 together with the electrolyte. In some embodiments, the electrode assembly 120 may be accommodated inside the can 110 so that the two winding axes AX1 and AX2 are normal (e.g., perpendicular) to the length direction of the cap assembly 130.

The can 110 may be shaped to be opened on one side (e.g., the upper side) so that the electrode assembly 120 may be inserted. After the electrode assembly 120 is accommodated in the can 110, the cap assembly 130 may be coupled to the can 110 to seal the can 110. The cap assembly 130 may include a cap plate 131 and an insulating plate 132. The cap plate 131 may include at least one electrode terminal 133. For example, one electrode terminal 133 may be installed on the cap plate 131 via an insulating gasket 134.

The insulating plate 132 may be positioned between the electrode assembly 120 and the cap plate 131, and may prevent or reduce the electrode assembly 120 from moving up and down. Two openings 135 and 136 corresponding to two electrode tabs 13 and 23 may be positioned in the insulating plate 132. The first electrode tab 13 may penetrate the first opening 135 and be fixed to the cap plate 131. The second electrode tab 23 may penetrate the second opening 136 and be fixed to the electrode terminal 133.

In the embodiment described above, the electrode terminal 133 may function as a positive terminal, and the entire cap plate 131 may function as a negative terminal. The cap assembly 130 shown in FIG. 1 is only an example, and cap assemblies of one or more suitable configurations may be applied.

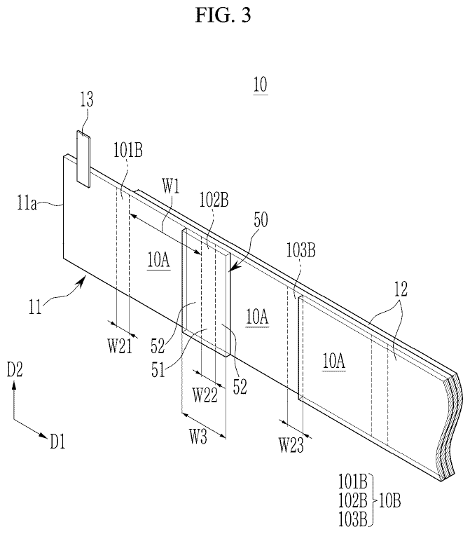

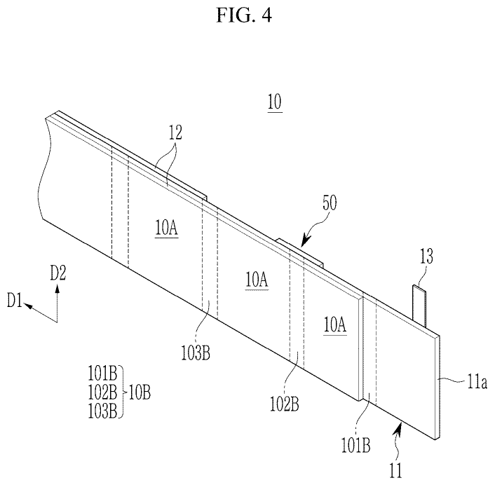

FIG. 3 and FIG. 4 are perspective views showing an unfolded state of a first electrode in an electrode assembly shown in FIG. 1. FIG. 3 shows the inner surface of the first electrode 10, and FIG. 4 shows the outer surface of the first electrode 10. Here, the inner surface is a surface positioned (facing) toward the center of the electrode assembly 120, and the outer surface is a surface positioned (facing) toward the outside of the electrode assembly 120 (i.e., facing away from the center).

Referring to FIG. 1 to FIG. 4, the first electrode 10 may be formed in a shape of a long strip and may include a plurality of flat portions 10A corresponding to the central portion 121 and a plurality of bent portions 10B corresponding to the pair of rounded portions 122. The flat portion 10A and the bent portion 10B may be positioned alternately one by one along the length direction of the first substrate 11 (direction D1 in FIG. 3 and FIG. 4).

In some embodiments, the plurality of flat portions 10A may have the same width W1. In some embodiments, among the plurality of flat portions 10A, one flat portion 10A in contact with the inner end 11a of the first substrate 11 may have a smaller width than the other flat portions 10A. The first electrode tab 13 may be fixed to the inner surface of the first substrate 11 close to the inner end 11a by using a method such as welding. The inner end 11a of the first substrate 11 is the end of the side where the winding starts, and is positioned at the innermost end of the electrode assembly 120.

The plurality of bent portions 10B may have a gradually larger width as they move away from the inner end 11a of the first substrate 11 (W21<W22<W23 . . . ). This is because as the winding of the laminate 40 progresses, the radius and circumference length of each of the pair of rounded portions 122 increase. The plurality of bent portions 10B may be referred to as a first bent portion 101B, a second bent portion 102B, and a third bent portion 103B in order of proximity to the inner end 11a. The “width” of the flat portion 10A and the bent portion 10B is a value measured along the length direction D1 of the first substrate 11 in the unfolded state of the first electrode 10.

The first composite material layer 12 may be positioned at a set or predetermined distance from the inner end 11a of the first substrate 11. For example, the first substrate 11 may include a region whose surface is not covered by the first composite material layer 12 and is exposed. The end position of the first composite material layer 12, where the first composite material layer 12 starts on the inner surface of first substrate 11, and the end position of the first composite material layer 12, where the first composite material layer 12 starts on the outer surface of the first substrate 11, may be different. That is, the position where the first composite material layer 12 starts on the inner surface of first substrate 11 (e.g., the distance from the inner end 11a of the first substrate 11) and the position where the first composite material layer 12 starts on the outer surface of the first substrate 11 (e.g., the distance from the inner end 11a of the first substrate 11) may be different.

On the inner surface of the first substrate 11, the first composite material layer 12 may be positioned further (space from) than a second bent portion 102B (is space from) from the inner end 11a to sufficiently secure a region to which the first electrode tab 13 will be attached. For example, on the inner surface of the first substrate 11, the end of the first composite material layer 12 may be positioned further than the third bent portion 103B from the inner end 11a.

The first composite material layer 12 on the outer surface of the first substrate 11 may be positioned closer to the inner end 11a than the first composite material layer 12 on the inner surface of the first substrate 11 is to the inner end 11a to increase capacity. On the outer surface of the first substrate 11, the end of the first composite material layer 12 may be positioned further from the inner end 11a than the first bent portion 101B is from the inner end 11a and is closer to the inner end 11a than the second bent portion 102B is to the inner end 11a.

The inner surface of the first substrate 11 may be exposed (e.g., may not be covered by the first composite material layer 12) from the inner end 11a to the third bent portion 103B. The outer surface of the first substrate 11 may be exposed (e.g., may not be covered by the first composite material layer 12) from the inner end 11a to the first bent portion 101B. The portion where the surface of the first substrate 11 is exposed because the first composite material layer 12 is not positioned may be referred to as an uncoated portion.

The active material (e.g., graphite) of the first composite material layer 12 allows a current to flow through an external circuit while reversibly absorbing and discharging lithium ions from the active material (e.g., lithium oxide) of the second composite material layer 22. During the charging and discharging of the rechargeable battery 100, lithium ions enter and exit the first composite material layer 12, and the volume of the first composite material layer 12 changes. For example, the first composite material layer 12 expands during the charging process, and the first composite material layer 12 contracts during the discharging process.

This volume change may cause damage to the electrode assembly 120 and may cause cracks to occur in structurally weak portions of the electrode assembly 120. Moreover, as recent high-capacity design trends have resulted in thinner first substrate 11 and denser first composite material layer 12, cracks may more easily occur in a comparable electrode assembly.

The structurally weak portion of the electrode assembly 120 may be the bent portion 10B where the first electrode 10 is bent, and of the plurality of bent portions 10B, may be the bent portions inside the electrode assembly 120 that are not covered by the first composite material layer 12 and are sharply bent (e.g., bent with a smaller radius of curvature). According to one or more embodiments, the first electrode 10 includes a protection layer 50 positioned on the inner surface of any one of the plurality of bent portions 10B that is not covered by the first composite material layer 12. In some embodiments, the protection layer 50 may overlap the second bent portion 102B among the plurality of bent portions 10B on the inner surface of the first substrate 11.

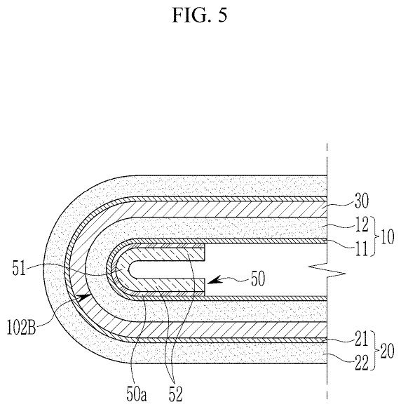

FIG. 5 is a partially enlarged view of a region where a protection layer is positioned among the electrode assembly shown in FIG. 1.

Referring to FIG. 3 to FIG. 5, the protection layer 50, which may be positioned on the inner surface of the second bent portion 102B, strengthens the second bent portion 102B. The protection layer 50 may be composed of a polymer film having an adhesive layer 50a, and may be firmly attached to the inner surface of the second bent portion 102B by the adhesive layer 50a.

The protection layer 50 may be attached to or coated on the first substrate by the adhesive layer 50a before winding the laminate 40, and may be bent along with the second bent portion 102B during the winding process of the laminate 40. The protection layer 50 may be composed of a polymer film such as polyimide (PI) and/or polyethylene terephthalate (PET), but the present disclosure is not limited thereto.

The width W3 of the protection layer 50 along the length direction D1 of the first substrate 11 may be greater than the width W22 of the second bent portion 102B. The height of the protection layer 50 along the width direction D2 of the first substrate 11 may be equal to or smaller than the height of the second bent portion 102B. The entire inner surface of the second bent portion 102B may be covered with the protection layer 50. A portion of the flat portion 10A in contact with the second bent portion 102B may also be covered with the protection layer 50.

The protection layer 50 may include a first portion 51 that overlaps the second bent portion 102B, and a pair of second portions 52 that are positioned on both sides (e.g., opposite sides) of the first portion 51 and overlap a portion of the flat portion 10A. The first portion 51 may be bent together with the second bent portion 102B, and may be stably fixed to the second bent portion 102B without changing the position thereof by the pair of second portions 52. In some embodiments, the thickness of the protection layer 50 may be equal to or greater than the thickness of the first substrate 11. In this case, the protection layer 50 may reinforce the second bent portion 102B more effectively.

Each of the pair of second portions 52 may have a width (according to the length direction D1 of the first substrate 11) from equal to the width W22 of the second bent portion 102B to equal to the width W1 of the flat portion 10A. For example, the minimum width of each of the pair of second portions 52 according to the length direction D1 of the first substrate 11 may be equal to the width W22 of the second bent portion 102B. The maximum width of each of the pair of second portions 52 may be equal to the width W1 of the flat portion 10A. However, the second portion 52 must not overlap the first composite material layer 12. When the second portion 52 has the width equal to the width W22 of the second bent portion 102B (e.g., the minimum width), the energy density of the rechargeable battery may increase by reducing the thickness of the electrode assembly 120. When the second portion 52 has the width equal to the width W1 of the flat portion 10A (e.g., the maximum width), the occurrence of wrinkles or cracks in the first electrode 10 may be effectively suppressed or reduced.

The electrode assembly 120 may strengthen the second bent portion 102B, which is relatively vulnerable to cracks, by using the protection layer 50, and may suppress or reduce cracks from occurring in the second bent portion 102B due to the repetition of the expansion and contraction during the charging and discharging processes of the rechargeable battery 100. In addition, the protection layer 50 may improve the manufacturing quality of the electrode assembly 120 by suppressing or reducing the occurrence of wrinkles in the first substrate 11 during the process of winding the laminate 40.

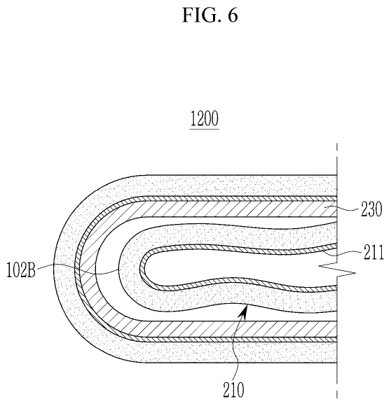

FIG. 6 is a schematic diagram showing an electrode assembly of a comparative example without a protection layer.

Referring to FIG. 6, in the electrode assembly 1200 of the comparative example, because there is no structure of maintaining the shape of a first substrate 211 around the second bent portion 102B, it becomes difficult for the first substrate 211 to maintain the intended shape of the second bent portion 102B inside of the separator 230. For example, the first substrate 211 may not maintain the intended shape on the inside of the separator 230, and wrinkles may occur.

If wrinkles occur in the first substrate 211, cracks may occur in the second bent portion 102B, and the first substrate 211 may not adhere closely to the separator 230, creating a space between the first electrode 210 and the separator 230, which may result in unintended by-products such as lithium precipitation and/or lithium dendrite formation. The generation of by-products inside the electrode assembly 1200 may lead to crack generation, which can cause an ignition of the electrode assembly 1200, and degrade the driving and lifespan characteristics of the rechargeable battery.

Again referring to FIG. 3 to FIG. 5, in the electrode assembly 120 of the embodiment, the second bent portion 102B may maintain the intended shape by the protection layer 50, and the occurrence of wrinkles in the first substrate 11 may be suppressed or reduced. In addition, the first electrode 10 may be maintained in close contact with the separator 30 in the second bent portion 102B, thereby preventing or reducing the generation of by-products due to space expansion.

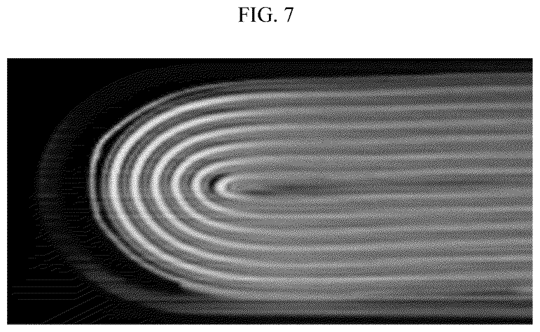

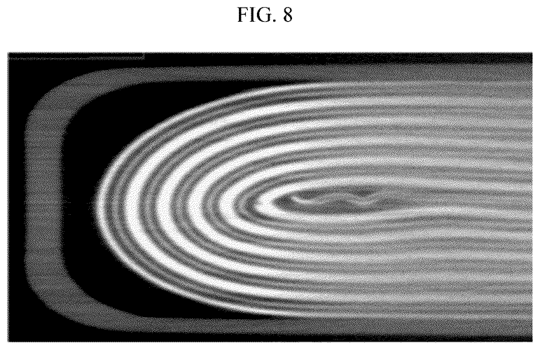

FIG. 7 is a partial enlargement of an electrode assembly of one or more embodiments equipped with a protection layer. FIG. 8 is a partial enlargement of an electrode assembly of a comparative example without a protection layer. In the electrode assembly of one or more embodiments shown in FIG. 7, a polyimide (PI) film with a thickness of 30 μm and a width of 10 mm was used as a protection layer.

Referring to FIG. 7, in the electrode assembly of the embodiment, it may be seen that there are no wrinkles on the first substrate and that there is no expanded space inside the electrode assembly. In contrast, referring to FIG. 8, in the electrode assembly of the comparative example, it may be seen that wrinkles occurred on the first substrate, and an expanded space was created inside the electrode assembly due to the wrinkles on the first substrate. In the expanded space, by-products may accumulate, such as lithium precipitation and/or lithium dendrite formation.

Again referring to FIG. 5, the protection layer 50 functions to reduce the stress applied to the second bent portion 102B of the first substrate 11. If the second bent portion without the protection layer bends sharply, the maximum stress increases, but the maximum stress decreases in the second bent portion 102B which is in contact with the protection layer 50.

The maximum stress applied to the second bent portion 102B in each of the electrode assemblies of the comparative example without a protection layer and the electrode assembly of one or more embodiments with a protection layer 50 is measured and shown in Table 1.

TABLE 1

| | Maximum stress (MPa) | Break stress (MPa) |
|---|---|---|
| Comparative example | 316.7 | 332.7 |
| Embodiment | 286.9 | 332.7 |

In both the comparative example and the embodiment, a first substrate includes (e.g., consists of) a copper foil with a thickness of 8 μm. In the embodiment, a polyimide (PI) film with a thickness of 30 μm and a width of 10 mm was used as the protection layer 50. Referring to Table 1, in the electrode assembly of the embodiment, it may be seen that the maximum stress of the second bent portion 102B is lower than that in the comparative example. The break stress shows the same result in the comparative example and the embodiment.

Table 2 shows a pin hole analysis of a second bent portion of an electrode assembly of Example 1 to Example 3 with three types (kinds) of protection layers of different thicknesses and materials, and an electrode assembly of a comparative example without a protection layer. Pin hole development in the second bent portion leads to (e.g., immediately leads to) the occurrence of cracking. In Example 1, the protection layer is a polyimide (PI) film with a thickness of 30 μm. In Example 2, the protection layer is a polyethylene terephthalate (PET) film with a thickness of 15 μm. In Example 3, the protection layer is a polyethylene terephthalate (PET) film with a thickness of 30 μm.

TABLE 2

| | Cycle number | | | | | |
|---|---|---|---|---|---|---|
| | 0 | 10 | 55 | 100 | 200 | 400 |
| Comparative | OK | NG | NG | — | — | — |
| example | (0F/10) | (9F/10) | (1F/1) | | | |
| Example 1 | OK | OK | OK | OK | OK | OK |
| | (0F/10) | (0F/10) | (0F/4) | (0F/1) | (0F/2) | (0F/5) |
| Example 2 | OK | OK | OK | OK | OK | NG |
| | (0F/5) | (0F/8) | (0F/12) | (0F/5) | (0F/3) | (3F/3) |
| Example 3 | OK | OK | OK | OK | OK | OK |
| | (0F/3) | (0F/3) | (0F/3) | (0F/3) | (0F/3) | (0F/3) |

In Table 2, OK refers to a result in which a pin hole did not occur, and NG refers to a result in which a pin hole occurred. Among the numbers in parentheses, the number after a slash (/) is the quantity of the sample that was disassembled and analyzed, and the number written with F in front of the slash (/) represents the quantity of the sample in which pin holes were confirmed among the samples that were disassembled and analyzed.

It may be seen that in the case of Example 2, no pinholes occurred in the second bent portion under a lifespan of 200 cycles, and in the case of Examples 1 and 3, no pinholes occurred in the second bent portion under a lifespan of 400 cycles. Although not included in Table 2, in the case of Example 1, no pin holes occurred until the long-term lifespan of 1000 cycles. It may be seen that the long-term cycle life characteristics are better (excellent or suitable) in Example 1 and Example 3, in which the protection layer is thicker than that of Example 2.

The rechargeable battery 100 of embodiment 1 may use the protection layer 50 to strengthen the second bent portion 102B of the first electrode 10, which is vulnerable to cracking. Therefore, the rechargeable battery 100 may suppress or reduce the occurrence of cracks in the second bent portion 102B and the generation of by-products inside the electrode assembly 120 in an environment where the expansion and contraction of the electrode assembly 120 are repeated during the charging and discharging process, and improve the driving stability and lifespan characteristics.

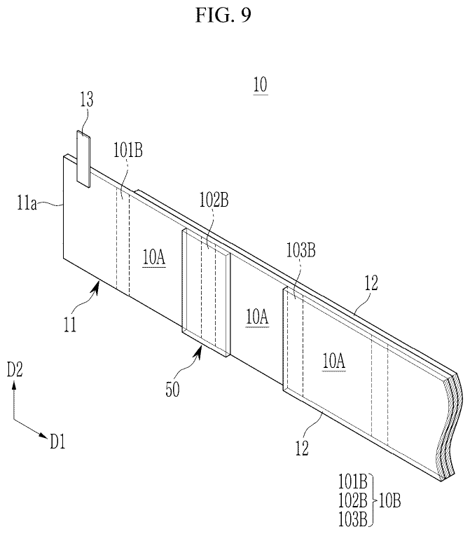

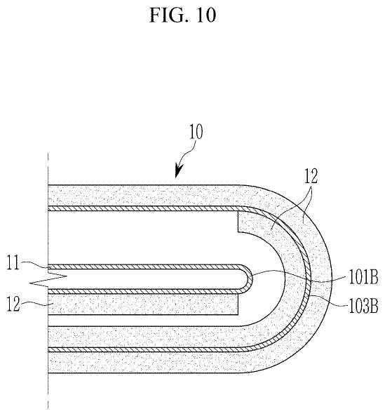

FIG. 9 is a perspective view showing an unfolded state of a first electrode in a rechargeable battery according to a second embodiment. FIG. 10 is a partial plan view showing a first electrode shown in FIG. 9 in a wound state. For convenience, a separator and a second electrode are not shown. The rechargeable battery of embodiment 2 has the same or a similar configuration as embodiment 1 described above, except for the configuration of the first electrode, which will be described next.

Referring to FIG. 9 and FIG. 10, on the inner surface of the first substrate 11, the first composite material layer 12 covers the third bent portion 103B. For example, on the inner surface of the first substrate 11, the end (edge) of the first composite material layer 12 may coincide with the end of the third bent portion 103B toward the second bent portion 102B.

Because the thickness of the first composite material layer 12 is greater than the thickness of the first substrate 11, the first composite material layer 12, which overlaps the third bent portion 103B, may function to strengthen the third bent portion 103B similar to the protection layer 50 of embodiment 1 and suppress or reduce the occurrence of cracks in the third bent portion 103B.

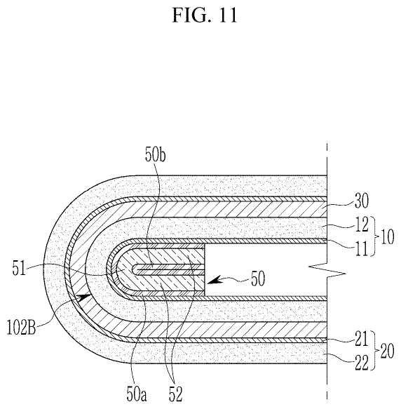

FIG. 11 is a partially enlarged view of an electrode assembly of a rechargeable battery according to embodiment 3. The rechargeable battery of embodiment 3 has the same or a similar configuration as either of embodiments 1 and 2 described above, except for a configuration of a protection layer, which is described next.

Referring to FIG. 11, the protection layer 50 may be composed of a polymer film with adhesive layers 50a and 50b on both surfaces (e.g., opposite surfaces or sides). The protection layer 50 may be firmly attached to the inner surface of the second bent portion 102B by the adhesive layer 50a positioned on the outer surface, and may be bent and folded in two along with the second bent portion 102B during the winding process of the laminate 40, and then the inner surfaces may be attached to each other by the adhesive layer 50b positioned on the inner surface. This protection layer 50 is effective in reducing the overall thickness of the protection layer 50 inside the electrode assembly.

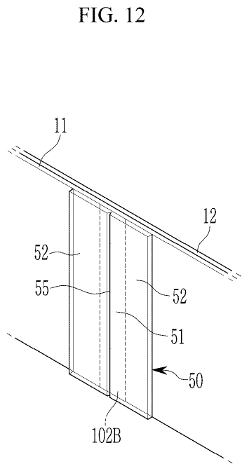

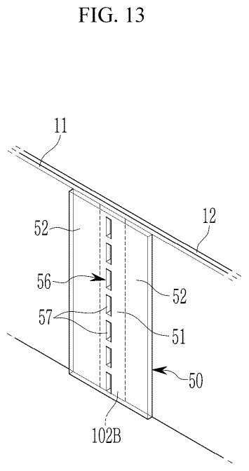

FIG. 12 and FIG. 13 are perspective views each showing an unfolding state of a first electrode of a rechargeable battery according to embodiment 4. The rechargeable battery of the fourth embodiment has the same or a similar configuration as any of embodiments 1 to 3 described above, except for a configuration of a protection layer, which is described next.

Referring to FIG. 12 and FIG. 13, the protection layer 50 may include folding lines 55 and 56 that are easily bendable. The folding lines 55 and 56 may be positioned parallel to the width direction D2 of the first substrate 11 if (e.g., when) the first substrate 11 is unfolded, and may be positioned in the first portion 51 that overlaps the second bent portion 102B. The folding lines 55 and 56 allow the protection layer 50 to be easily folded if (e.g., when) the protection layer 50 is bent along with the second bent portion 102B.

The folding lines 55 and 56 may be composed of a straight line of grooves or a plurality of slits 57 aligned side by side with a distance therebetween. FIG. 12 shows the folding line 55 including (e.g., consisting of) the straight line of the grooves, and FIG. 13 shows the folding line 56 including (e.g., consisting of) the plurality of slits 57. The configuration of the folding lines 55 and 56 is not limited to the examples shown, and may be altered in one or more suitable manners.

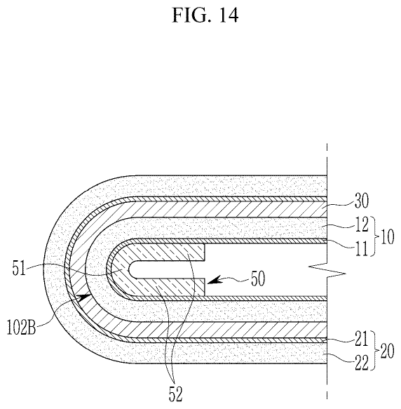

FIG. 14 is a partially enlarged view of an electrode assembly of a rechargeable battery according to embodiment 5. The rechargeable battery of embodiment 5 has the same or a similar configuration as either of embodiments 1 and 2 described above, except for a material of a protection layer, which is described next.

Referring to FIG. 14, the protection layer 50 may be composed of a coating film including at least one of polyimide (PI), polyethylene terephthalate (PET), ceramics, or negative active material. In this embodiment, the negative active material may include graphite, conductive material, binder, and/or the like, and may be composed of components such as the first composite material layer 12. The protection layer 50 may be coated on the first substrate 11 before the winding of the laminate 40, and may be bent along with the second bent portion 102B during the winding process of the laminate 40.

While FIG. 1 shows a small prismatic battery, the electrode assembly according to one or more embodiments may also be applied to medium to large-sized rechargeable batteries. Below, the medium to large-sized rechargeable batteries are described.

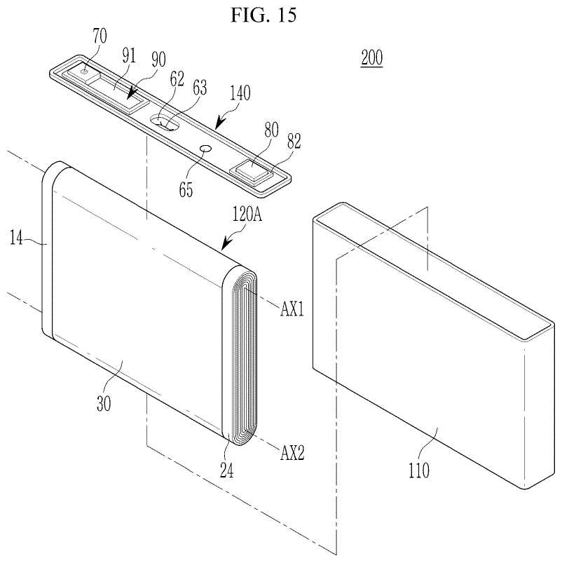

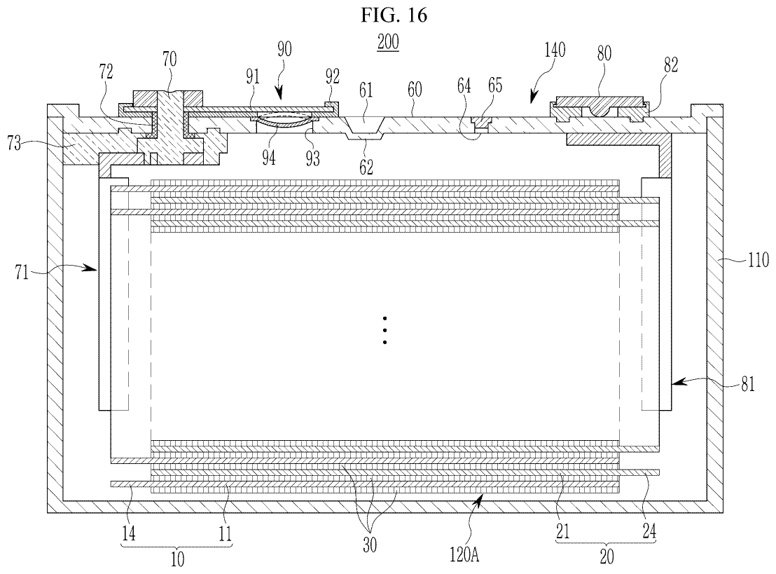

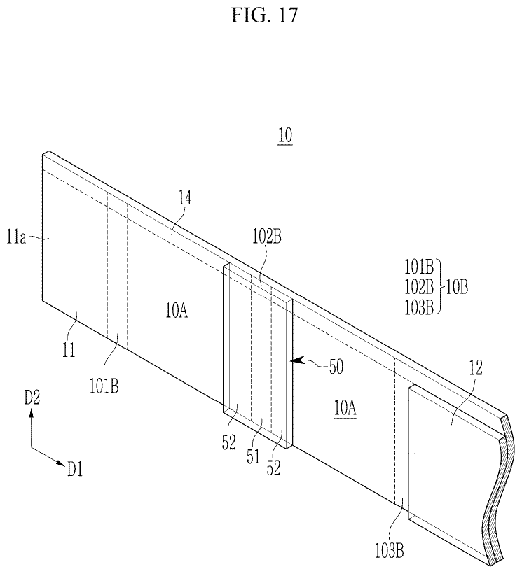

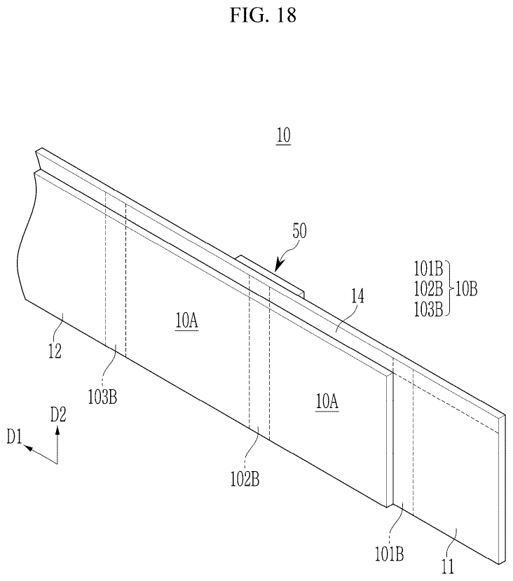

FIG. 15 is an exploded perspective view of a rechargeable battery according to embodiment 6. FIG. 16 is a cross-sectional view of a rechargeable battery according to embodiment 6. FIG. 17 and FIG. 18 are perspective views showing an unfolded state of a first electrode of an electrode assembly shown in FIG. 15. FIG. 17 shows the inner surface of the first electrode, and FIG. 18 shows the outer surface of the first electrode. The rechargeable battery of embodiment 6 has the same or a similar configuration as any one of embodiments 1 to 5 described above, except for a configuration of an electrode assembly and a cap assembly, which is described next.

Referring to FIG. 15 to FIG. 18, the electrode assembly 120A is wound around the two winding axes AX1 and AX2 (that parallel to and are spaced from each other), thereby having the shape of a flat jelly roll. The electrode assembly 120A may be accommodated inside the can 110 so that the first and second winding axes AX1 and AX2 are aligned in the length direction of the cap assembly 140.

The first electrode 10 may include a first substrate 11 and the first composite material layer 12 positioned on the first substrate 11. The first electrode 10 may include a first tab portion 14 extending from the first substrate 11 to one side (a left side in FIG. 16, an upper side in FIG. 17 and FIG. 18). The first tab portion 14 may be parallel to the length direction D1 of the first substrate 11. The first composite material layer 12 is not positioned in the first tab portion 14, and the first tab portion 14 may be referred to as a negative uncoated region.

The second electrode 20 may include a second substrate 21 and a second composite material layer 22 positioned on the second substrate 21. The second electrode 20 may include a second tab portion 24 extending from the second substrate 21 to the opposite side (a right side in FIG. 16). The second tab portion 24 may be parallel to the length direction of the second substrate 21. The second composite material layer 22 is not positioned in the second tab portion 24, and the second tab portion 24 may be referred to as a positive uncoated region. The first tab portion 14 and the second tab portion 24 may be positioned on opposite sides. In FIG. 16, for convenience, the illustration of the first composite material layer 12 and the second composite material layer 22 is not shown.

The protection layer 50 may overlap the second bent portion 102B among the plurality of bent portions 10B on the inner surface of the first substrate 11. The protection layer 50 may include a first portion 51 that overlaps the second bent portion 102B and a pair of second portions 52 that are positioned at or on both sides (e.g., opposite sides or surfaces) of the first portion 51 and overlap a portion of the flat portion 10A. FIG. 17 shows that the protection layer 50 overlaps the first tab portion 14, but in some embodiments, the protection layer 50 may not overlap the first tab portion 14.

The cap assembly 140 may include a cap plate 60, a first terminal 70, a second terminal 80, and a safety apparatus 90 installed on the cap plate 60. The cap plate 60 may be fixed to the end of the can 110 by using a method such as welding.

The first terminal 70 is electrically connected to the first electrode 10 by a first connection portion 71 fixed to the first tab portion 14 and may function as a terminal (a negative terminal) of the first electrode 10. The cap plate 60 may be electrically connected to the second electrode 20 by a second connection portion 81 fixed to the second tab portion 24. The second terminal 80 may function as a terminal (a positive terminal) of the second electrode 20 by being in contact with the cap plate 60.

The first terminal 70 may be insulated from the cap plate 60 by a negative electrode gasket 72 and a negative insulating portion 73. A positive insulating portion 82 may be positioned between the cap plate 60 and the edge of the second terminal 80. The second terminal 80 may be in point-contact with the cap plate 60. For convenience, in FIG. 15, the first connection portion 71 and the second connection portion 81 are not shown.

The safety apparatus 90 may include a short-circuit tab 91, an insulating plate 92, a short-circuit hole 93, and a short-circuit member 94. The short-circuit tab 91 may be electrically connected to the first terminal 70. The insulating plate 92 may insulate the cap plate 60 and the short-circuit tab 91. The short-circuit hole 93 may be positioned on the cap plate 60, and the insulating plate 92 may be provided with an opening corresponding to the short-circuit hole 93. The short-circuit member 94 may be installed on the cap plate 60 to close and seal the short-circuit hole 93 and may be charged with the same polarity as the cap plate 60.

The short-circuit member 94 has a convex shape toward the electrode assembly 120A and is spaced and/or apart (e.g., spaced apart or separated) from the short-circuit tab 91 to maintain an insulating state from the short-circuit tab 91. In one or more embodiments, a gas may be generated in the electrode assembly 120A due to a rapid charge, and/or the like, which may increase the internal pressure of a rechargeable battery 200. In this case, the short-circuit member 94 may be inverted by internal pressure to contact the short-circuit tab 91.

The rechargeable battery 200 may safely discharge the current charged in the electrode assembly 120A to the outside by this external short circuit. At this time, the part where the positive electrode terminal 80 and the cap plate 60 are in point-contact may melt and break, and the rechargeable battery 200 may become a stable neutral cell.

The cap plate 60 may include a vent hole 61 and a vent plate 62, and a notch 63 may be provided in the vent plate 62. When the internal pressure of the rechargeable battery 200 increases, the vent plate 62 is cut from the notch 63, thereby discharging the internal gas of the rechargeable battery 200. In FIG. 16, a symbol 64 represents an electrolyte injection opening, and a symbol 65 represents a stopper that seals the electrolyte injection opening 64.

In the context of the present application and unless otherwise defined, the terms “use,” “using,” and “used” may be considered synonymous with the terms “utilize,” “utilizing,” and “utilized,” respectively.

Throughout the disclosure, the expression “at least one of a, b or c”, “at least one selected from a, b, and c”, “at least one selected from the group consisting of a, b, and c”, “at least one from among a, b, and c”, etc., indicates only a, only b, only c, both (e.g., simultaneously) a and b, both (e.g., simultaneously) a and c, both (e.g., simultaneously) b and c, all of a, b, and c, or variations thereof.

The use of “may” when describing embodiments of the present disclosure refers to “one or more embodiments of the present disclosure”.

As used herein, the terms “substantially”, “about”, and similar terms are used as terms of approximation and not as terms of degree, and are intended to account for the inherent deviations in measured or calculated values that would be recognized by those of ordinary skill in the art. “About” or “approximately,” as used herein, is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” may mean within one or more standard deviations, or within +30%, 20%, 10%, 5% of the stated value.

Any numerical range recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein.

Unless otherwise defined, in the present disclosure, the term “diameter” refers to an average diameter when particles or parts are spherical or circular and refers to an average major axis length when particles or parts are non-spherical or non-circular.

The display device, and/or any other relevant devices or components according to embodiments of the present invention described herein may be implemented utilizing any suitable hardware, firmware (e.g., an application-specific integrated circuit), software, or a combination of software, firmware, and hardware. For example, the various components of the device may be formed on one integrated circuit (IC) chip or on separate IC chips. Further, the various components of the device may be implemented on a flexible printed circuit film, a tape carrier package (TCP), a printed circuit board (PCB), or formed on one substrate. Further, the various components of the device may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the scope of the embodiments of the present disclosure.

Although the embodiments of the present disclosure have been described, it is understood that the present disclosure should not be limited to these embodiments, but one or more suitable changes and modifications can be made by one ordinary skilled in the art within the spirit and scope of the present disclosure as hereinafter claimed and equivalents thereof.

While this invention has been described in connection with what is presently considered to be practical example embodiments, it is to be understood that present disclosure is not limited to the disclosed embodiments, but, on the contrary, is intended to cover one or more suitable modifications and equivalent arrangements included within the spirit and scope of the appended claims, and equivalents thereof.

What is claimed is:

1. An electrode assembly comprising:
a first electrode;
a second electrode; and
a separator between the first electrode and the second electrode,
wherein,
the separator, the first electrode, and the second electrode are wound around two winding axes and are in a shape comprising a central portion and two rounded portions at opposite sides of the central portion, and
the first electrode comprises:
a first substrate having an inner end, an inner surface, and a bent part spaced from the inner end;
a first composite material layer on a part of the first substrate spaced from the inner end; and
a protection layer on the inner surface of the first substrate at the bent part and spaced from the first composite material layer.

2. The electrode assembly of claim 1, wherein:
the first substrate comprises a plurality of flat portions corresponding to the central portion and a plurality of bent portions corresponding to the two rounded portions, and
on the inner surface of the first substrate, the first composite material layer is positioned across two or more bent portions of the plurality of bent portions from the inner end of the first substrate.

3. The electrode assembly of claim 2, wherein:
the plurality of bent portions comprises a first bent portion, a second bent portion, and a third bent portion, the first to third bent portions being arranged in order of proximity to the inner end, and
the protection layer overlaps the second bent portion.

4. The electrode assembly of claim 3, wherein:
on the inner surface of the first substrate, the first composite material layer overlaps the third bent portion.

5. The electrode assembly of claim 3, wherein:
the protection layer comprises:
a first portion that overlaps the second bent portion; and
two second portions at opposite sides of the first portion and each overlapping a portion of the plurality of flat portions.

6. The electrode assembly of claim 5, wherein:
a width of each of the two second portions along a length direction of the first substrate is greater than or equal to a width of the first portion and less than or equal to a width of a flat portion of the plurality of flat portions.

7. The electrode assembly of claim 1, wherein:
the protection layer comprises a polymer film and an adhesive layer on at least one surface of the polymer film, the protection layer being attached to the first substrate.

8. The electrode assembly of claim 7, wherein:
the protection layer comprises a folding line at the bent part, the folding line being parallel to a width direction of the first substrate.

9. The electrode assembly of claim 1, wherein:
the protection layer comprises a coating film comprising at least one of polyimide (PI), polyethylene terephthalate (PET), a ceramic, or a negative active material.

10. An electrode assembly comprising:
a positive electrode;
a negative electrode; and
a separator between the positive electrode and the negative electrode,
wherein,
the separator, the positive electrode, and the negative electrode are wound around two winding axes and are in a shape comprising a central portion and two rounded portions at opposite sides of the central portion, and
the negative electrode comprises:
a substrate having an inner end and an inner surface;
a composite material layer; and
a protection layer,
wherein the substrate comprises a plurality of flat portions corresponding to the central portion and a plurality of bent portions corresponding to the two rounded portions, the plurality of bent portions comprising a first bent portion, a second bent portion, and a third bent portion, the first to third bent porting being arranged in order of proximity to the inner end,
on the inner surface of the substrate, the composite material layer is further away from the inner end than the second bent portion is from the inner end, and
the protection layer is on the inner surface of the substrate at the second bent portion.

11. The electrode assembly of claim 10, wherein:
a width of the protection layer along a length direction of the substrate is more than three times a width of the second bent portion, and
a thickness of the protection layer is greater than a thickness of the substrate.

12. The electrode assembly of claim 10, wherein:
the protection layer comprises a polymer film attached to the substrate by an adhesive layer or a coating film formed by being coated on the substrate.

13. The electrode assembly of claim 12, wherein:
the protection layer comprises the polymer film and a folding line parallel to a width direction of the substrate.

14. The electrode assembly of claim 10, wherein:
the composite material layer overlaps the third bent portion on the inner surface of the substrate.

15. A rechargeable battery comprising:
an electrode assembly of claim 1;
a can to accommodate the electrode assembly; and
a cap assembly coupled to an end of the can and to seal the can.

16. A rechargeable battery comprising:
an electrode assembly of claim 10;
a can to accommodate the electrode assembly; and
a cap assembly coupled to an end of the can and to seal the can.
